(19) United States
(12) Patent Application Publication
(10) Pub. No.: US 2005/0190744 A1
(43) Pub. Date: Sep. 1, 2005

(54) Method of informing a callee of an attempted telephone call by means of internet protocol messaging

(76) Inventors: Xian-He Sun, Darien, IL (US); Vijay K. Gurbani, Lisle, IL (US)

Correspondence Address: Roland W. Norris;Pauley Petersen & Erickson, Suite 365, 2800 West Higgins Road, Hoffman Estates, IL, 60195, US

(21) Appl. No.: 10/788,620

(22) Filed: Feb. 27, 2004

(51) Int. Cl. H04L 12/66

(52) U.S. Cl. 370/352; 370/401

(57) ABSTRACT

A method is provided for communication between a telephone caller and a callee of the telephone call in the event of an attempted public switched telephone network (PSTN) call within the PSTN. The attempted call may result from deliberate failure of the callee to answer the telephone or may result from a failure of the PSTN to route the call to the callee. The method includes the linking of a public switched telephone network with an Internet domain network via a PSTN/Internet domain network interface; and upon detection of the attempted PSTN call, having the PSTN inform the Internet domain network interface to provide an message in real time to the intended recipient of the PSTN call via an Internet protocol message. In the case of a PSTN network failure to deliver the call, the PSTN may inform the Internet domain network interface to provide the message in real time via an Internet protocol to a caller-selected list of recipients as well as the callee of the PSTN call when an abnormality is detected in the PSTN. In the case where the callee does not wish to be disturbed with a telephone call, the callee can inform at least one of the PSTN or the Internet domain network interface to provide the message to the callee in real time via an Internet protocol.

### DISCUSSION OF THE RELATED ART

The public switched telephone network (PSTN) is ubiquitous in many societies. However, in many instances of telephone calls, the callee, that is the intended recipient, is away from the telephone receiver or merely wishes not to engage in a telephone conversation at a particular time, resulting in one instance of an “attempted call.” “Attempted call” as used herein refers to a call which is placed by the caller and generally, although not necessarily, does not result in an interactive voice communication with the callee, i.e., a recipient accepting the call at the dialed telephone number. For other examples, the call may be received by a voice-mail system, or the call may not be deliverable to the telephone unit of the intended recipient due to network failure.

However, in many such instances, the callee may still wish to be informed that a caller had tried to reach the callee via the telephone. Such a capability may be very important for business, medical, or personal reasons, especially in disaster situations. In other extreme instances, such as overloading of call volume or physical destruction of PSTN equipment, the telephone network may not be physically able to deliver a telephone call from the caller to the callee. In these instances the caller might wish to inform the callee that the caller had tried to reach the callee via the telephone. For example, there is a need in the art to reliably let emergency first responders get the attention of other first responders. There is a further need in the art to let a private citizen inform his or her loved ones of the private citizen's well being during times of adverse conditions.

Many such callees now have access to a second communications network, namely the Internet. The Internet has the capability to deliver real-time instant messages or email messages which may be delivered in near real time, or both, apart from the telephone network. It would therefore be desirable to allow a callee to be informed that a caller had tried to reach the callee on the PSTN without reliance on the PSTN. It is further desirable in many instances that the notification to the callee be automatic in nature and deliver a short notification message merely detailing the existence of the call, i.e., essential network details of the call such as time, originating telephone number, location, and caller identification, rather than a lengthy message dictated by the caller.

While the inventor is aware of known systems which seek to utilize the capabilities of both the PSTN and the Internet, there is not believed to be a system in the known art which provides communication between a telephone caller and a callee of the telephone call including a simple, real-time method of quickly and automatically notifying a callee of the essential details of an attempted call. There is thus a need in the art to allow a callee to be quickly and automatically notified of the essential details of an attempted call.

### SUMMARY OF THE INVENTION

There are currently two nearly ubiquitous networks in use: the PSTN and the Internet. Whereas the former is a specialized network whose main objective is to transport voice-based media with low delay and a guaranteed quality of service, the latter is a general-purpose network which can transport arbitrary media, including voice, video, and data. Increasingly, these networks are merging and the union of these networks has lead to open questions on at least two planes: the transport plane, i.e., the protocols and procedures for digitizing and transporting voice as packets over an inherently best-effort delivery network, and the service plane, i.e., the protocols and procedures for enabling new services and accessing existing services between the networks.

The present invention generally deals with the service plane, and is part of an overall approach for enabling what is sometimes referred to herein as “crossover services,” i.e., services where the intelligence to execute the services is distributed in multiple network domains. A request to start a crossover service generally originates in one domain (PSTN or Internet) but terminates in another domain. Thus, there are generally two types of crossover services: those that originate on the Internet and terminate on the PSTN (termed as Internet-originated crossover services), and those that originate on the PSTN and terminate on the Internet (termed as PSTN-originated crossover services). The present invention largely pertains to the latter category, i.e., the PSTN is the network on which the request for a call is initially received, but the services for the session are provided on the Internet (IP) domain.

The present invention provides a method of communication between a telephone caller and a callee of the telephone call whereby a callee can be quickly and automatically notified of the essential details of an attempted call from a caller by a network other than the PSTN.

A method of providing communication between a telephone caller and a callee of the telephone call according to the present invention may include the linking of a PSTN with an Internet domain network via a telephone network/internet domain network interface; the detection of an attempted call within the PSTN; and upon detection of the attempted PSTN call, having the PSTN inform the Internet domain network interface to provide an message in real time (such as by IM), or near real time (such as by email), to the intended recipient of the PSTN call via an Internet protocol. While the present invention is referred to for explanatory purposes in terms of public networks such as PSTN and Internet, it will be appreciated that other networks such as private branch exchanges and internets other than the public Internet or the World Wide Web may be suitably configured and benefit from the teachings of the present invention.

In aspects of the invention where an abnormality is detected in the PSTN, e.g., the PSTN cannot physically route the call to the callee, the PSTN can inform the Internet domain network interface to provide a message in real time via an Internet Protocol (IP) to the callee of the PSTN call if previously directed to do so by the caller. The caller may also have directed an Internet agent to provide the attempted call information to other parties on a caller-selected list of recipients. This crossover service can be provided so long as the caller's call has reached a switching point of the PSTN.

In aspects of the invention where the attempted call is of the type which can be physically completed by the PSTN but the callee does not wish to engage in answering the call, the callee can give advance knowledge, or directions, to the system of the present invention that failure to answer the telephone call can be expected and that a message should be delivered via the Internet when a call to the callee's number is sensed. In this instance, the callee will request the PSTN to inform the IP domain service provider to send the callee notification via an Internet protocol in real time of the attempted calls to the callee.

In some aspects of the invention the message delivered via the Internet can be a discrete preprogrammed message. The message can be an Instant Message and is desirably, although not necessarily, a text message for speed of delivery and low hardware requirements. In some aspects of the invention the message delivered via the Internet can be an email.

Consider the following scenario: Bob, a callee, arrives at work only to discover that his cellular telephone's battery has lost power. Bob is expecting an important call from his wife Alice, a caller, but is not planning to be at his desk near his wire line phone. Bob would like to be notified on the IP network of his portable personal digital assistant (PDA) when Alice attempts to call his cell telephone or wire line telephone (on the PSTN) so that he can immediately return Alice's call.

Clearly, the services Bob expects are not simple. The complexity arises because the services of telephone and IM notice do not reside in the same network or use homogeneous protocols. What Bob would like to do when Alice calls him is to have the PSTN notify him on his PDA, which may be on the wireless Internet. The present invention provides a means to tie services across the two networks of PSTN and the Internet in a transparent and standardized manner.

A key requirement of any PSTN-originated crossover service may be third-party programmability of such services. Arguably, the service creation framework for the world wide web (WWW) infrastructure has thrived since it enables third parties to provide value-added services over a common transport, namely IP. One of the most important factors for the success of WWW services has been a common lingua franca (HTTP/HTML) and an extensive service creation toolset (e.g., Web CGI, Active Server Pages, Java scripts, servlets, SOAP, WDSL, UDDI, etc.).

Telephony, on the other hand, has traditionally been an environment where the inner workings of the protocols and services, while not entirely secret, were not subject to as much public access and scrutiny as Internet protocols have been. It is believed by the inventors that the web model of allowing open, well-defined protocols needs to be replicated for PSTN-originated crossover services. To that extent, aspects of the present invention allow an open, extensible architecture for crossover services based on standard protocols to help third parties in developing such services.

PSTN-originated crossover service architecture may resemble a distributed software architecture. Such architectures employ distributed middleware (CORBA, RMI) to design systems. However, the present invention eschews these middleware technologies in favor of industry standard signaling protocols for call control and data/state transfer. Services are best executed when the service execution platform has unfettered access to the signaling information. Application Program Interfaces, (APIs), tend to shield the programmer from the details of the signaling protocol. Thus, the present invention desirably uses Session Initiation Protocol (SIP) as an exemplary distributed middleware component for PSTN-originated crossover services as described herein.

### BRIEF DESCRIPTION OF THE DRAWINGS

The aspects of this invention will be better understood from the following detailed description taken in conjunction with the drawings wherein:

FIG. 1 is a simplified overview of a crossover services exchange according to one aspect of the invention.

FIG. 2 is a graphical user interface suitable for use with aspects of the present invention.

FIG. 3 is a simplified overview of a crossover services exchange according to another aspect of the invention.

FIG. 4 is a simplified overview of a PSTN operation.

FIG. 5 is a simplified overview of an Internet domain operation.

FIG. 6 is a proposed architecture of a crossover services system operation according to aspects of the present invention.

FIG. 7 is a simplified overview of message transfer for the crossover services system operation according to aspects of the present invention.

### DETAILED DESCRIPTION OF THE PREFERRED EMBODIMENTS

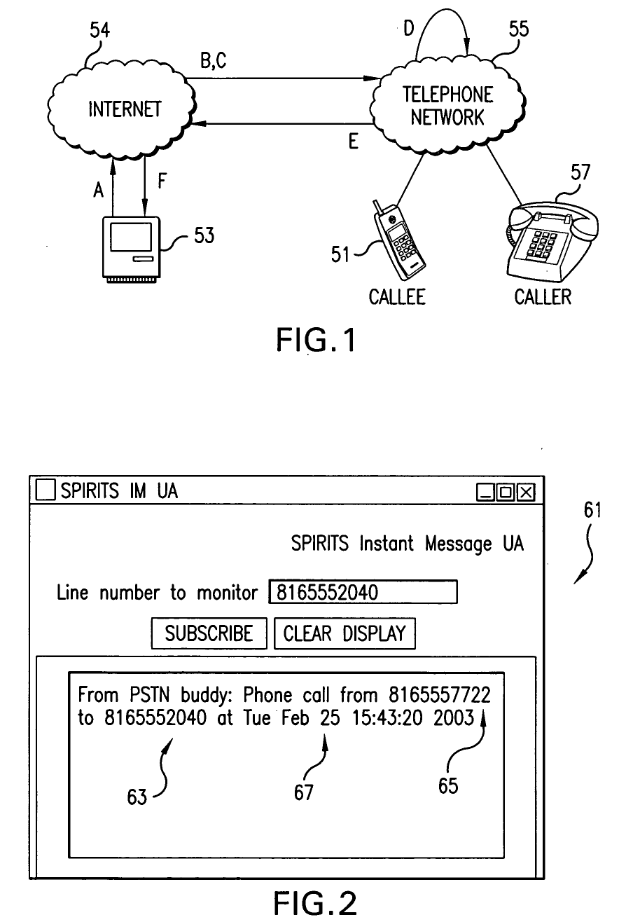

FIG. 1, illustrates a first aspect of the present invention, where an owner, or callee, (not shown) of a telephone line 51 is physically far away from his or her fixed line telephone or the cellular telephone. In the case of the fixed land line, the owner may not be at home where the fixed line is located. In the case of the cellular telephone, the owner may have forgotten the telephone at home or the telephone may be in the possession of the owner but may have run out of battery power. If the owner of the telephone line has possession of an Internet-capable device 53 that is connected to the Internet 54 such as a desktop computer, a laptop computer, or a personal digital assistant (PDA), and the owner of the telephone line 51 would not like to miss a call arriving at the telephone line, the owner of the telephone line can be notified on the Internet-capable device 53 by an Instant Message (IM) as soon as the telephone network 55 detects that a party, e.g. calling line 57, is attempting to call the owner of the telephone line 51. The crossover service then operates as follows, with the letters in FIG. 1 corresponding to the steps described:

Step A: A telephone line user, or callee, is interested in receiving notifications of incoming call to telephone 51 in real time on his or her IM service. An IM agent is started by the callee on an Internet-capable device 53 (which is assumed to be connected to the Internet 54).

Step B: The IM agent registers the preference of the callee with the telephone network 55. The preference is to be informed in real-time about an incoming call to any of the designated telephone lines, e.g. 51, at the disposal of the telephone line user (callee).

Step C: The telephone network 55 authenticates the IM agent and registers the Internet address of the IM agent and the preferences of the telephone line user.

Step D: The telephone network 55 undertakes appropriate actions to ensure that incoming calls to the designated callee telephone lines, e.g. 51, identified in Step B result in a notification action.

Step E: When a caller on another line 57 calls the callee line 51, the actions in Step D are executed. In this case, the telephone network 55 captures the incoming call information (the caller's name and telephone number, the time of day that the call occurred, etc.) and creates an IM out of this information. The IM is then routed through the Internet 54 to the Internet address of the IM agent of the callee registered in Step C.

Step F: The IM is displayed in the Internet-capable device 53 for the consumption of the callee, i.e., user of telephone line 51.

The most visible benefit of the invention is that a telephone line user has up to date information on calls being made to his or her telephone line. This has advantages in many instances where a telephone line user cannot be physically close to a fixed telephone or may not have his or her cellular telephone in possession, or the cellular telephone may have discharged its battery. In such cases, if the callee is expecting an important call, this invention makes it possible to notify him or her of this event. As reachability of people becomes more important, this invention makes it possible to rendezvous two individuals who may otherwise miss each other.

FIG. 2 is the Graphical User Interface displayed to the callee for implementing the present invention on an Internet capable device 53. The telephone line that the callee is interested in receiving an IM for is 8165552040. When an incoming call arrives at the telephone line 8165552040, the telephone network sends an IM to the telephone line user's IM User Agent. The User Agent displays the IM 63 showing pertinent call information such as calling party 65 and time and date of call 67. These events correspond to steps E and F.

Currently, the Intelligent Network component (IN) of a PSTN can deduce, as discussed below in connection with the Detection Points of Table 1, the difference between a normal busy condition, i.e., the callee is on a call with someone else, and an abnormal busy condition, such as when all routes emanating from a particular telephone switch are not available. The former event is given normal treatment to the initiator of the call; namely, if the recipient of the call has call waiting, the call waiting tone will be generated; or the caller will receive a busy signal. The latter event is usually associated with an error condition of some sorts. Telephone networks are engineered such that an event which corresponds to all routes not being available does not occur with any regular frequency. This occurrence signifies an error condition. Normally when this error condition happens, the caller cannot do anything to notify the callee or anyone else. The present invention allows the caller to subscribe to a service in the PSTN which will format and send an Internet IM or email to a single callee or a list of recipients.

The event which corresponds to PSTN routes not being available typically manifests itself under disaster-like conditions, such as Sep. 11, 2001 or the August 2003 Northeastern United States power blackout.

The caller, who may be a first responder or a private citizen, may specify a list of recipients the caller would like notified under a PSTN failure scenario. Each designated recipient will be identified with an email Universal Resource Identifier (URI) and an IM URI. When the telephone network cannot route the calls instigated by the caller, the cross over services servers such as detailed herein will be alerted to the PSTN failure condition. Thus, as long as the caller's intended call did get to a switching center, the PSTN switch can analyze the dialed-from number (corresponding to the caller) and the dialed-to number (corresponding to the callee), and depending on the outcome of the analysis, run a service which will send an Internet IM or email to the callee or a list of IM recipients designated by the caller. If the recipient is also a first responder, he can respond appropriately. If the recipient is a private citizen, he can rest assured that his loved one is okay.

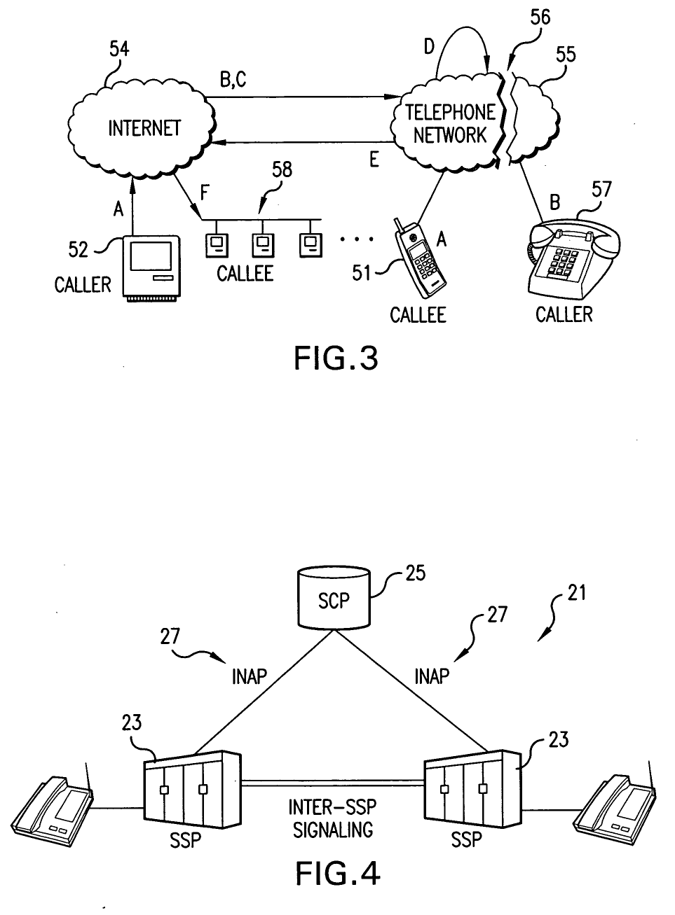

Referring to FIG. 3, in this aspect of the invention, cross over services can report to the callee of a telephone call adverse conditions in the telephone network 55 which preclude the caller's call from being completed as illustrated by the break in the PSTN connection at 56.

In Step A: A telephone line user, or caller, is interested in providing outgoing call notifications when emergency conditions warrant to the callee telephone line 51 in real time on the callee's Internet service. The caller starts an IM agent on his Internet-capable device 52 (which is assumed to be connected to the Internet 54).

Step B: The IM agent registers the preference of the caller 57 with the telephone network 55. The preference is to inform callees, desirably in real time via an IM, about an attempt by the caller 57 to call to any of the designated telephone lines, e.g. 51, at the disposal of the telephone line callee.

Step C: The telephone network 55 authenticates the IM agent and registers the Internet address of the IM agent and the preferences of the caller 57.

Step D: The telephone network 55 undertakes appropriate actions to ensure that outgoing calls to the designated callee telephone lines, e.g. 51, identified in Step B result in a notification action to the callee list when a PSTN interruption/service failure is detected within the PSTN.

Step E: When a PSTN interruption/service failure is detected within the PSTN the actions in Step D are executed. In this case, the telephone network 55 captures the incoming call information (the caller's name and telephone number, the time of day that the call occurred, etc.) and creates an IM out of this information. The IM is then routed through the Internet 54 to the Internet address of the IM agent of the callee registered in Step C.

Step F: The IM is displayed in the Internet-capable devices 58 of the callee, or list of designated recipients.

The callee is thus informed of the failure of the PSTN 55 through the Internet 54, desirably in real time through an Instant Message (IM) or possibly by receiving an electronic mail (email) at some later point in time. The IM or email can also be transmitted to a list of recipients 58 designated by the caller 57 upon the caller's attempt to use the failed PSTN 55.

An exemplary model of the present invention is given herein to help the reader understand the various actions, protocols, and architectures involved in the execution of a crossover service. Generally, according to the preferred embodiment, there are three parties of interest in a PSTN-originated crossover service: 1) the PSTN service provider, 2) the Internet service provider, and 3) the end user of the service.

The PSTN service provider owns and/or operates the PSTN network on which events are generated. The end user is the party in the IP domain which requests the PSTN service provider to monitor events of interest for service execution. Finally, the Internet service provider is the party that provides the IP transport to the end user. The PSTN service provider and Internet service provider can belong to the same organization, but they do not have to. As a general rule, it is assumed that they are not part of the same organization.

As known in the art, the Intelligent Network (IN) is used in the PSTN to provide services such as 800-number translation, pre-paid calling, etc. A overview is provided below of the main entities of the IN.

Referring to FIG. 4, a simplified PSTN IN architecture 21 is shown in which the telephone switches called Service Switching Points 23 are connected via a packet network called Signaling System 7 (SS7) to a general purpose computer called a Service Control Point 25. This leads to a clean separation of components since call control and service switching functions are performed at the Service Switching Point 23, while the service control (and data) functions are hosted by the Service Control Point 25.

The Service Control Point 25, along with other peripherals, not shown, (like a media server for prompting and digit collection or voice recognition) provide services to PSTN subscribers. Service Switching Points 23 run a call model called Basic Call State Model when handling a call. A call model is basically a directed graph which accurately and concisely reflects the current state of a call at any given point in time (it is used to synchronize the many distributed entities that may participate in a call).

Call models consist of states called Points In Call (PIC) and transitions between states. Inter-state transitions deliver elements called Detection Points (Table 1). Detection Points house one or more triggers. Every trigger has a firing criteria associated with it. When a trigger is armed (made active), and its associated firing criteria are satisfied, it fires. When a trigger fires, a message is formatted with call state information and transmitted by a Service Switching Point 23 to the Service Control Point 25.

TABLE 1
SET OF VALUES FOR E_{V} RELATED TO A TELEPHONE
CALL (WIRE LINE OR CELLULAR)

| Detection | |
|---|---|
| Point | Comment |
| OAA | Caller is authorized to make a call |
| AI | Dialed digits have been analyzed |
| CI | All dialed digits have been collected |
| OA | Callee has answered the call |
| OTS | Callee is being alerted |
| TANS | Callee has picked up the phone |
| ONA | Caller's BCSM timed out waiting for the callee to answer |
| RSF | Caller's BCSM is unable to send signaling messages |
| | on selected route |
| TNA | Callee was alerted, but did not answer within a |
| | predefined time interval |
| OCB | Callee is busy |
| OMC | Caller's BCSM detected mid-call activity (‘hook |
| | flash’, for instance) |
| TMC | Callee's BCSM detected mid-call activity (‘hook |
| | flash’, for instance) |
| OAD | Caller abandoned the call (i.e. hung up) before |
| | signaling was complete |
| OD | Caller disconnected the phone (i.e. normal hang up) |
| TAB | Callee abandoned the call (i.e. hung up) before |
| | signaling was complete |
| TD | Callee disconnected the phone (i.e. normal hang up) |
| TAA | Callee can receive an incoming call |
| FSA | Callee is not busy, and a line or trunk is available |
| | to reach the callee |
| TB | Callee is busy |

Further call processing may be suspended at the Service Switching Point 23 until the Service Control Point 25 returns a response. When the Service Control Point 25 gets a request for instructions, it can reply with a single response, such as simple number translation augmented by criteria like time of day or day of week, or, in turn, get into a complex dialog with the Service Switching Point 23 which may involve playing or recording voice announcements and collecting digits. The resulting protocol as well as the Basic Call State Model is standardized by the International Telecommunications Union (ITU-T) and is known as the Intelligent Network Application Protocol (INAP) 27.

The term PSTN here represents both the wire line and wireless aspects of the switched network. Specifically, the current wireless services infrastructure (2G, 2.5G) is heavily influenced by the concepts of IN discussed above and is well integrated in the PSTN. Much like wire line IN, Wireless IN is based on an architecture that separates call processing from enhanced feature functionality. The wireless services infrastructure uses the same set of IN components used by their wire line counterparts, including the Service Control Point 25. An important difference in wireless networks is that there are many events generated outside the context of establishing a call; for instance, turning on a mobile telephone results in a registration event at the network and roaming in a wireless network generates location update events.

The service architecture for Internet telephony is still evolving. The architecture of the PSTN has been characterized by a centralized control. The PSTN core, in the form of the Service Switching Point 23, the Service Control Point 25, etc., asserts control over the signaling, media, and services being provided to the end points. Architectures for the Internet, on the other hand, tend to follow the opposite path; i.e. the network core is fairly simple while the intelligence is distributed to the end points. A service architecture for Internet telephony is therefore no exception, and the lack of central control makes it a complex problem.

A brief overview of executing services in the Internet using the Session Initiation Protocol (SIP) is provided below. SIP is described elsewhere in the art more completely.

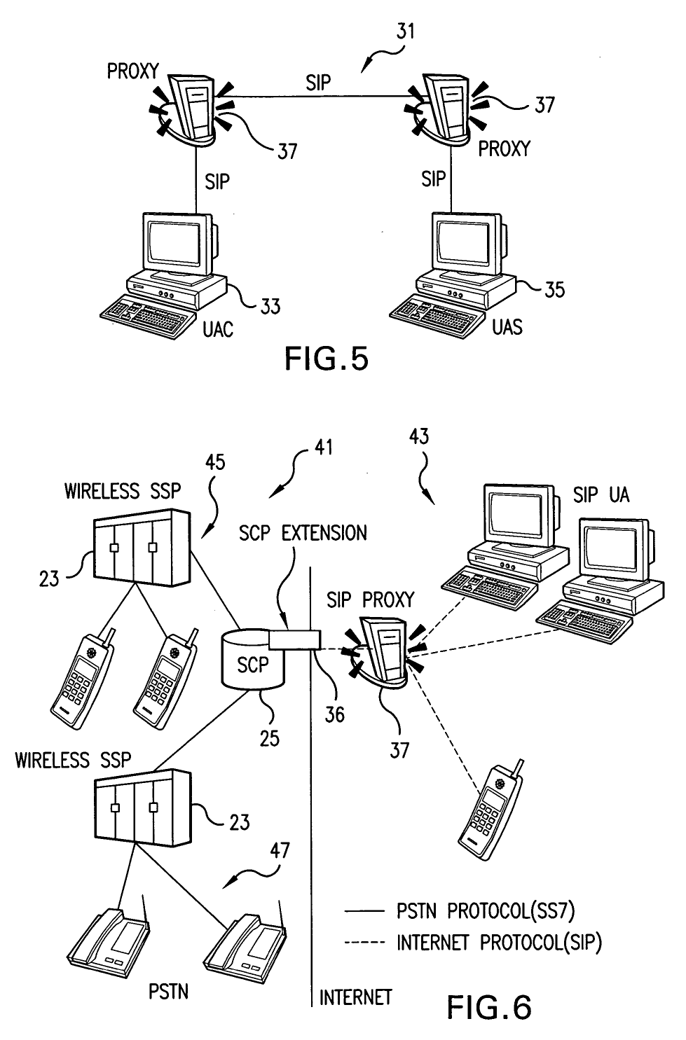

Referencing FIG. 5, SIP is an ASCII-based protocol used to initiate, maintain, modify, and terminate multimedia sessions. It shares its ancestry with other ASCII-based protocols from the Internet Engineering Task Force (IETF), including SMTP and HTTP, on which it is largely based. A SIP network 31 is depicted in FIG. 5 and includes User Agents 33, 35 that resides on the periphery of the network.

There are 2 types of User Agents: 1) User Agent Clients 33 which make requests for establishing sessions, and 2) User Agent Servers 35 which accept these requests and issue responses.

SIP, like HTTP, is a transaction-based protocol, where a transaction consists of a request and some responses. In the core of a SIP network reside network-based servers, the most important one for the present discussion being a SIP proxy server 37. The main task of a SIP proxy server 37 is to route requests from User Agent Clients 33 to User Agent Servers 35 based on many factors, including local registration information, such as DNS, SIP CGI, and SIP CPL. Additionally, SIP proxies can also be used to provide other services, such as authentication of incoming requests and authorization of protected resources identified in the request.

Services in a SIP network can be provided at multiple places. Since SIP endpoints (user agents) are far more capable in terms of functionality than their PSTN counterparts, they can actively participate in a service. Thus, originating side services can be provided by the User Agent Client 33 and the terminating side ones by the User Agent Server 35. Network-resident SIP entities can also provide services which involve media as well as services based purely on signaling.

In direct contrast with the PSTN, which uses INAP for service execution and another protocol (SS7) for inter-switch signaling, and yet another protocol for switch to endpoint signaling, a distinguishing factor of SIP is that the protocol used for signaling and service execution is the same. This distinction is leveraged in aspects of the present invention by abstracting the entire PSTN as a SIP endpoint and using SIP signaling to deliver service requests from the PSTN to the Internet (FIG. 6).

A PSTN-originated crossover service occurs when the PSTN performs an event of interest to an Internet host. When the event of interest occurs, the PSTN must take a snapshot of the call and transfer it to the Internet host for service execution. Depending on the service, the PSTN may actually await further instructions from the Internet host. Thus, a first desirable property of a useful protocol for crossover services is a simple transactional, request-response driven signaling that has proved durable on the Internet (witness the success of HTTP, FTP, etc.). A request-response property in the target protocol will aid in synchronizing the entities on the PSTN and IP network by allowing the PSTN to temporarily suspend call processing until the Internet host has returned further instructions.

A second desirable property of a useful protocol for crossover services is the ability to carry arbitrary descriptive elements between the two networks. This will enable the Internet host to inform the PSTN of events of interest, and conversely, allow the PSTN to take a snapshot of a call in progress and intimate the Internet host of it.

A third desirable property of a useful protocol for crossover services is support of a flexible naming scheme. Resources in the PSTN are generally identified by numbers, but in the IP network, resources can be identified using a much richer vocabulary which includes names, numbers, domains, etc.

SIP has been chosen as a desirable protocol according to certain aspects of the invention. SIP, following other IETF protocols, is a transactional protocol with a simple request-reply nature. SIP has built-in support for carrying arbitrary descriptive elements during signaling using the IETF Multipurpose Internet Mail Extensions (MIME). MIME allows communicating entities to exchange any arbitrary data on the Internet; inter-operability is provided by registering new MIME types in a global registry. Also, SIP has extensive support for a flexible naming scheme in the form of a SIP URL. SIP also possesses built-in support for asynchronous event notification and enables services like presence and instant messaging that may be viewed as vital components of crossover services.

There are three conditions for a service to be considered a PSTN-originated crossover service:
1. Subscription: An Internet host subscribes to an event of interest in the PSTN,
2. Action: The PSTN, during its normal course of operations, undertakes certain actions which lead to the occurrence of the event of interest,
3. Notification: The PSTN notifies the Internet host of event of interest and the service itself is executed on the Internet. Depending on the taxonomy of the service, it may be completely executed on the Internet, or the service execution may be shared between the two networks.

A target architecture should support Internet hosts subscribing to events of interest occurring in the PSTN and the subsequent notification of the said event of interest by the PSTN to the concerned Internet host. Aspects of the present invention supply an architecture for PSTN-originated crossover services that meets the three conditions outlined above. The architecture is simple, and in keeping with the Internet tradition, distributes the intelligence to the edges of the network. In fact, according to certain aspects of the present invention, the entire PSTN can be simply viewed as a SIP User Agent to provide crossover services.

FIG. 6 illustrates an architecture of the present invention showing the PSTN domain 41 on the left hand side of the diagram and the Internet (IP) domain 43 on the right hand side. As previously noted, the PSTN domain 41 can be considered to consist of both wireless 45 and wire line 47 components. An SCP Extension 36 serves as an access point resident in and belonging to the PSTN infrastructure, with the SCP extension also having access to the Internet domain). SCP Extension 36 provides for communications with the IP domain SIP proxy server 37. The SCP extension 36 further interfaces with the PSTN elements such that it gets notified when the event of interest within the PSTN occurs. The SCP extension 36 in turn, notifies the appropriate Internet host which had subscribed to the event through the SIP proxy. The SIP proxy 37 acts as a gatekeeper for the PSTN resources by authenticating and authorizing the subscription requests arriving from the Internet hosts.

In order to send subscriptions from the Internet host (and notifications from the PSTN) in a standardized manner, the present invention uses Extensible Markup Language (XML) to carry tuples S (subscribe) and N (notify) from the Internet to the PSTN, and from the PSTN to the Internet, respectively. An Internet host subscribes to an event of interest represented by a finite tuple S=(eᵥ, eₘ, e¹ᵥ, e²ᵥ, . . . , eⁿᵥ), with n≧1, where:

eᵥ: The event that is being subscribed to. For events generated as a result of a telephone call on the wire line or cellular network, the set of valid values for eᵥ are given in Table I. The set of events in the cellular network not related to a telephone call are depicted in Table II.

eₘ: The mode of the event; =eₘ={notify, request}. A mode of notify requires the PSTN to simply notify an Internet host of the event. A mode of request requires that the PSTN temporarily suspend its processing and await instructions from the Internet host on how to proceed further.

e¹ᵥ, . . . , eⁿᵥ: Additional parameters relevant to eᵥ. For example, in most cases, one of the parameters sent during subscription will be a telephone number about which the Internet host seeks notifications for. Any PSTN action that leads to the execution of eᵥ on that telephone number will be of interest to the Internet host. The notification tuple is represented by N=(eᵥ, e¹ᵥ, e²ᵥ, . . . , eⁿᵥ), with n≧0. Note that N does not contain the component em, and any additional information besides eᵥ is optional.

TABLE II
SET OF VALUES FOR E_{V} RELATED
CELLULAR NON-CALL EVENTS

| Event | Comment |
|---|---|
| LUS | Location update in home area |
| LUA | Location update while roaming outside the home area |
| IA | Mobile registration |
| MSID | Mobile de-registration (mobile initiated) |
| NID | Mobile de-registration (network initiated) |
| SUP | Supplementary services |

The decision to use SIP as the protocol of choice is desirable in this instance since SIP can carry arbitrary bodies (defined by a MIME type in a SIP header). Delivering tuples S and N as XML-encapsulated SIP payloads yields a descriptive, extensible and standards based codification scheme. Considerable work has been conducted in the art to identify and categorize the Detection Points and their relevant parameters, non-call related events, and defining XML schemas for S and N.

In order to use PSTN-originated crossover services, a specialized User Agent (not shown) may be made available to end users by the PSTN service provider or a third-party working with the service provider. The specialized User Agent, in addition to supporting the base SIP functionality, will also support the SIP extension for asynchronous event notification, the SIP extensions for instant messaging and presence, and the extensions to enable it to understand and interpret tuples S and N discussed above. The specialized User Agent will also be pre-configured with the address of a SIP proxy in the domain of the PSTN service provider which will be contacted for all PSTN-originated crossover services. Furthermore, it is not expected that the end user will be conversant with XML in order to formulate the event of interest S or interpret the notification N. Rather, the PSTN service provider will codify the events it supports in a Graphical User Interface to make it easier for the end user to choose events of interest. The specialized User Agent will construct the appropriate XML based on the user selection and send it to the pre-configured SIP proxy.

The technique of crossover services according to the present invention will now be discussed. The first example entails a crossover service that involves notifications of the event selected by the callee occurring on a certain PSTN line. The second example entails a crossover service that involves notifying the callee or a list of recipients selected by the caller that a call has been placed to their phone line(s) in the event of a PSTN failure. Both examples generally entail a crossover service that involves notification of the callee of events occurring on a certain PSTN line. Therefore, the technique of the crossover services will be exemplified by reviewing the steps for an Incoming call announcement. It will be understood that the second example will operate similarly but will depend upon a different Detection Point within the PSTN, such as e.g., the Detection Point RSF, as listed in Table 1, and will generally be directed by the caller rather than the callee.

The first example service scenario is thus: a user at work wishes to be notified whenever someone calls her home telephone. She is possibly expecting an important call, the arrival of which she would like to know instantaneously, or may be simply generating a real-time log of calls to her home telephone. It will be appreciated that it is possible to have the present invention also log attempted calls that include calls which were actually answered by the callee as well as those which did not result in interactive voice communications. From her Internet host, she subscribes to the PSTN for a specific Detection Point which will get fired whenever an incoming call is destined to her home line. When the event of interest occurs in the PSTN, the Service Control Point extension sends a notification to the Internet host.

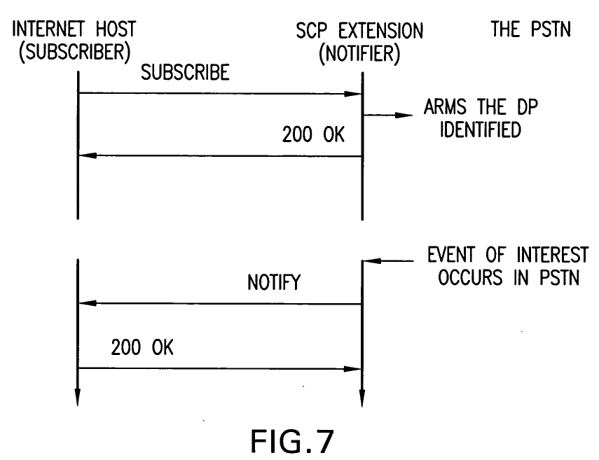

Referring to FIG. 7, the call flow is reproduced. Note that only the relevant entities are depicted in FIG. 7; for instance, while the SIP access proxy 37 from FIG. 6 is employed to authenticate the user and proxy the messages, the proxy is not shown for reasons of brevity. Of interest in the SUBSCRIBE request that is sent from the Internet host is the body of the request (while relevant headers are shown, others are omitted for brevity) as follows:

SUBSCRIBE sip:myprovider.com SIP/2.0
From: <sip:xyz@someaddress.com>;tag=8177-afd-991
To: <sip:15557778888@myprovider.com>
Event: spirits.INDPs
Allow-Events: spirits.INDPs, spirits.user-prof
Accept: application/spirits-event
Content-Type: application/spirits-event
Content-Length: 221
<spirits-event>
<DP INDPs=TAA/>

<Mode>Notify</Mode>
<Termination_Attempt_Authorized>

<CallingPartySubaddress>5557778888</CallingPartySubaddress>

</Termination_Attempt_Authorized>

</spirits-event>

The body of the SUBSCRIBE request contains an XML formatted payload, which in this particular case, identifies the Detection Point that it wants to subscribe to (TAA—Termination Attempt Authorization Detection Point; this Detection Point is triggered in the T_BCSM on attempts to complete a call on a particular telephone line) and parameters associated with the Detection Point. The TAA Detection Point (DP) is defined with one mandatory parameter, the calling party's telephone number, encoded by the XML element CallingPartySubaddress. Based on the information in the SUBSCRIBE request, the PSTN arms the Detection Point, and when a telephone call attempts to complete on the line identified by the CallingPartySubaddress, a notification is sent to the Internet host. The notification request (N) travels from the PSTN to the Internet host as:
NOTIFY sip:xyz@someaddress.com SIP/2.0
From: <sip: 15557778888@myprovider.com>; tag=SA-5557778888
To: <sip:xyz@someaddress.com>; tag=8177-afd-991
Subscription-State: terminated; reason=fired
Accept: application/spirits-event
Event: spirits.INDPs
Allow-Events: spirits.INDPs, spirits.user-prof
Content-Type: application/spirits-event

Content-Length: 263

<spirits-event>
<DP INDPs=TAA/>

<Termination_Attempt_Authorized>

<CallingPartySubaddress>15557778888</CallingPartySubaddress>
<CalledPartySubaddress>15557779999</CalledPartySubaddress>

</Termination_Attempt_Authorized>

</spirits-event>

The body of this NOTIFY request contains the Detection Point that was fired (TAA) and any associated parameters. In this example, two parameters are passed from the PSTN to the Internet host: the line number that was being monitored for events (identified by the CallingPartySubaddress element) and the number of the party that attempted to place a call to that line (identified by the CalledPartySubaddress element).

The notification that goes from the PSTN to the Internet host has all the elements required for a call announcement service. The Internet host can subsequently alert the user, e.g., by popping up an IM window with the relevant information. It is also entirely possible to send an instant message with more detailed information to the Internet host. This can be accomplished by the PSTN sending a special request in SIP (the MESSAGE extension) used specifically for instant messages.

The present invention has presented a means for realizing crossover services. Aspects of the present invention's protocol and architecture provide ease of use and flexibility in creating crossover services for the set of call related events (Detection Points) presented in Table I. Additional crossover services resulting from non-call related events in the cellular network may be implemented.

The hardest part in an architecture that includes multiple entities and spans network topologies is identifying a good synchronization and message passing protocol. The exemplary choice of SIP as the protocol of choice is believed to be a sound one. The entire PSTN can abstracted as a SIP UA for crossover services. The advantages that this abstraction provides are multiple. For one, the PSTN entities do not know (nor do they care) that a portion of the service is being executed on a foreign domain, namely the Internet. Furthermore, the usage of SIP enables the present invention to transport call-related data in a standard signaling protocol between different entities, synchronizing them and passing information between them in one attempt. Finally, the architecture presented further separates the services plane from the call signaling information; services occur on one network, the signaling stimulus for them occurs on another network. It believed that this separation will help third party service providers to innovate novel services, some of which have been exemplified herein.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

1. A method of providing communication between a telephone caller and a callee of the telephone call, comprising:
a) linking a switched telephone network with an internet network via a telephone network/internet domain network interface;
b) detecting an attempted call within the switched telephone network;
c) upon detection of the attempted call, having the switched telephone network inform the telephone network/internet domain network interface to provide a message reporting details of the attempted call to the callee via the internet network.

2. The method of providing communication between a telephone caller and a callee of the telephone call according to claim 1, wherein the switched telephone network is a public switched telephone network.

3. The method of providing communication between a telephone caller and a callee of the telephone call according to claim 2, wherein the internet network is the public Internet.

4. The method of providing communication between a telephone caller and a callee of the telephone call according to claim 3, wherein the public switched telephone network informs the telephone network/internet domain network interface to provide the message via an Internet protocol to the callee of the public switched telephone network call when an abnormality is detected in the public switched telephone network which prevents the public switched telephone network from completing the call connection between the caller and the callee.

5. The method of providing communication between a telephone caller and a callee of the telephone call according to claim 4, wherein the telephone network/internet domain network interface provides the message via an Internet protocol to a caller-selected list of recipients as well as the callee of the public switched telephone network call.

6. A method of providing communication between a telephone caller and a callee of the telephone call according to claim 1, wherein the callee informs at least one of the public switched telephone network or the Internet domain network interface to provide the message to the callee in real time via an Internet protocol when the attempted call is intended for the telephone number of the callee.

7. A method of providing communication between a telephone caller and a callee of the telephone call according to claim 1, wherein the message details at least one of the telephone number trying to reach the callee, the caller identification of the telephone number trying to reach the callee, and the time of the attempted call.

8. A method of providing communication between a telephone caller and a callee of the telephone call according to claim 1, wherein the message is an Instant Message provided in real time.

9. A method of providing communication between a telephone caller and a callee of the telephone call according to claim 1, wherein the message is a text message.

10. A method of providing communication between a telephone caller and a callee of the telephone call according to claim 1, wherein the message is an email.

11. A method of providing communication between a telephone caller and a callee of the telephone call, comprising:
a) linking a public switched telephone network with an Internet domain network via a service control point extension for the public switched telephone network and an SIP proxy server for an Internet domain network service provider;
b) detecting an attempted public switched telephone network (public switched telephone network) call within the public switched telephone network;
c) upon detection of the attempted public switched telephone network call, having the public switched telephone network inform the Internet domain network service provider to provide a message reporting details of the attempted call in real time to the callee of the public switched telephone network call via an Internet protocol.

12. A method of providing crossover services, between an internet domain and a switched telephone network domain comprising the steps of:
a) starting an IM agent for a callee on an Internet-capable device to express interest in receiving notifications of incoming calls on a telephone line of the callee;
b) having the IM agent register the interest of the callee with the telephone network;
c) having the telephone network authenticate the 14 agent and register the Internet address of the IM agent and the interest of the callee;
d) having the telephone network undertake appropriate actions to ensure that incoming calls to the callee telephone line result in a notification action;
e) executing the actions in step d) a when a caller on another line calls the callee telephone line by capturing the incoming call information and creating an Instant Message out of the incoming call information;
f) routing the Instant Message through the Internet to the Internet address of the IM agent of the callee registered in step c); and
g) displaying the Instant Message on an Internet-capable device for the consumption of the callee.

13. A method of providing crossover services, between an internet domain and a switched telephone network domain comprising the steps of:
a) starting an IM agent for a caller on an Internet-capable device to express interest in providing outgoing call notifications of the caller to the callee or other designated phone lines;
b) having the IM agent register the preference of the caller with the telephone network to inform callees about an attempt by the caller to call the callee or any of the designated telephone lines,
c) having the telephone network authenticate the IM agent and register the Internet address of the IM agent and the preferences of the caller;
d) having the telephone network undertake appropriate actions to ensure that outgoing calls to the callee or designated telephone lines identified in step b) result in a notification action to the callee list when a telephone network service failure is detected within the telephone network;
e) executing the actions in Step d) when a telephone network interruption/service failure is detected within the telephone network including having the telephone network capture the incoming call information and
f) creating a message out of the incoming call information;
g) routing the message through the Internet to the Internet address of the IM agent of the callee or designated telephone lines registered in step c); and
h) displaying the message in Internet-capable devices of the callee, or of persons on the list of designated telephone lines.
